(19) United States
(12) Patent Application Publication
(10) Pub. No.: US 2026/0175531 A1
(43) Pub. Date: Jun. 25, 2026

(54) COMPACTOR SAFETY SYSTEM WITH ELECTROMAGNETIC SENSING

(71) Applicant: The Heil Co., Chattanooga, TN (US)

(72) Inventors: Brian Huston Ham, Huntsville, AL (US); David C. Gentry, Chattanooga, TN (US); Patrick Stewart Carroll, Chattanooga, TN (US)

(21) Appl. No.: 19/423,909

(22) Filed: Dec. 17, 2025

Related U.S. Application Data
(60) Provisional application No. 63/736,518, filed on Dec. 19, 2024.

(51) Int. Cl. B30B 15/26; B30B 15/14; B30B 15/16

(52) U.S. Cl. CPC B30B 15/26; B30B 15/148; B30B 15/166

(57) ABSTRACT

A compactor system includes: a container body; a packer; and an actuator configured to operate the packer to compact refuse within the container body; an electromagnetic sensor device configured to detect objects near the compactor system and to generate sensor data indicating the detected objects near the compactor system; a control system configured to perform operations including: receiving the sensor data generated by the electromagnetic sensor device, wherein the sensor data indicates a detected object; classifying the detected object as a non-refuse object based on the sensor data; determining that the non-refuse object is likely inside the container body; and in response to determining that the non-refuse object is likely inside the container body, controlling the actuator to prevent compaction of the refuse by the packer. Classifying the detected object as a non-refuse object can include classifying the detected object as a living object.

### CROSS-REFERENCE TO RELATED APPLICATION

This application claims the benefit of the U.S. Provisional Patent Application No. 63/736,518, filed Dec. 19, 2024, which is incorporated herein by reference in its entirety.

### TECHNICAL FIELD

This disclosure relates to refuse compactor systems.

### BACKGROUND

A trash compactor is a waste container with a crushing mechanism that reduces the size of solid waste. The compactor uses an actuator such as a hydraulic piston or auger to compress and crush refuse, reducing its size and volume such that the refuse can fit into a container. The container can then be picked up by a waste management company for disposal or recycling. Refuse compactor systems can provide many benefits for businesses including reducing the volume of refuse, reducing costs associated with hauling refuse, reducing odors and fire damage, and protecting against pests.

### SUMMARY

Compactors increase the amount of trash that can be hauled in a load. Uncompacted refuse containers have empty space, even when they are overflowing with refuse. A compactor compacts the refuse in order to more efficiently use the space in the container. As a result, more refuse can be held in less space, which in turn reduces the frequency of refuse hauls and saves time and cost. Commercial trash compactors are a secure and clean waste management solution. Trash compactors reduce the risk of theft, vandalism, and pests, all while requiring little maintenance, training, or attention.

Compactor operation can be dangerous when a non-refuse object such as a living object enters the compactor. The techniques described herein can be used to detect a non-refuse object entering a compactor, and to prevent compaction operations inside the compactor when a non-refuse object enters the compactor.

In general, innovative aspects of the subject matter described in this specification can be embodied in a compactor system including: a container body; a packer; and an actuator configured to operate the packer to compact refuse within the container body; an electromagnetic sensor device configured to detect objects near the compactor system and to generate sensor data indicating the detected objects near the compactor system; and a control system configured to perform operations including: receiving the sensor data generated by the electromagnetic sensor device. The sensor data indicates a detected object. The operations include classifying the detected object as a non-refuse object based on the sensor data; determining that the non-refuse object is likely inside the container body; and in response to determining that the non-refuse object is likely inside the container body, controlling the actuator to prevent compaction of the refuse by the packer.

In general, innovative aspects of the subject matter described in this specification can be embodied in a method of operating a compactor system including a container body, a packer, and an actuator configured to operate the packer to compact refuse within the container body. The method includes: receiving sensor data generated by an electromagnetic sensor device that is configured to detect objects near the compactor system, determining that the sensor data indicates a detected object; classifying the detected object as a non-refuse object based on the sensor data; determining that the non-refuse object is likely inside the container body; and in response to determining that the non-refuse object is likely inside the container body, controlling the actuator to prevent compaction of the refuse by the packer.

In general, innovative aspects of the subject matter described in this specification can be embodied in a non-transitory computer storage medium encoded with instructions that, when executed by one or more computers, cause the one or more computers to perform operations for operating a compactor system including a container body, a packer, and an actuator configured to operate the packer to compact refuse within the container body. The operations include: receiving sensor data generated by an electromagnetic sensor device that is configured to detect objects near the container body, determining that the sensor data indicates a detected object; classifying the detected object as a non-refuse object based on the sensor data; determining that the non-refuse object is likely inside the container body; and in response to determining that the non-refuse object is likely inside the container body, controlling the actuator to prevent compaction of the refuse by the packer.

These and other implementations can each optionally include one or more of the following innovative features. In some implementations, classifying the detected object as a non-refuse object includes classifying the detected object as a living object.

In some implementations, classifying the detected object as a living object includes classifying the detected object as a human or animal.

In some implementations, the electromagnetic sensor device has a sensing area defined at least in part by a maximum sensing range, and determining that the non-refuse object is likely inside the container body includes: determining that the detected object departed the sensing area of the electromagnetic sensor device; and determining that the detected object did not pass through the maximum sensing range of the electromagnetic sensor device.

In some implementations, determining that the non-refuse object is likely inside the container body includes: determining, based on the sensor data, that the non-refuse object entered the container body through an opening.

In some implementations, determining that the non-refuse object is likely inside the container body includes: determining, based on the sensor data, that the non-refuse object did not depart from the container body after the object entered the container body.

In some implementations, classifying the detected object as a non-refuse object includes: generating a point cloud from the sensor data; and performing object classification using the point cloud.

In some implementations, classifying the detected object as a non-refuse object includes classifying the detected object as a human; and determining that the non-refuse object is likely inside the container body includes: determining, based on the sensor data, that the human approached the compactor system; receiving door sensor data from a door sensor configured to detect a position of a door to the compactor system; and determining that the human is likely inside the container body in response to determining, based on the door sensor data, that that the door opened after the human approached the compactor system.

In some implementations, classifying the detected object as a non-refuse object includes classifying the detected object as a living object; and determining that the non-refuse object is likely inside the container body includes: determining, based on the sensor data, that the living object approached the compactor system; receiving door sensor data from a door sensor configured to detect a position of a door to the compactor system; and determining that the living object is likely inside the container body in response to determining, based on the door sensor data, that the door was open when the living object approached the compactor system.

In some implementations, a refuse object is an object to be disposed.

In some implementations, the operations include: determining that the non-refuse object has exited the container body; and receiving second sensor data generated by the electromagnetic sensor device. The sensor data indicates a second object. The operations include classifying the second object as a refuse object based on the sensor data; and in response to (i) determining that the non-refuse object has exited the container body and (ii) classifying the second object as a refuse object, determining not to control the actuator to prevent compaction of the refuse by the packer.

In some implementations, the operations include: providing, for presentation on a display, a visual representation of the sensor data.

In some implementations, the operations include: in response to determining that the non-refuse object is likely inside the container body, activating an alarm.

In some implementations, the electromagnetic sensor device includes an electromagnetic transceiver.

In some implementations, the electromagnetic sensor device includes a radar sensor or a lidar sensor.

In some implementations, the electromagnetic sensor device is mounted to the compactor system or to a structure near the compactor system.

In some implementations, the compactor system includes a stationary compactor.

In some implementations, the electromagnetic sensor device has a sensing area that includes at least part of an interior volume of the container body, and determining that the non-refuse object is likely inside the container body includes determining that the sensor data generated by the electromagnetic sensor device includes a detection of the non-refuse object in the interior volume of the container body.

In some implementations, the electromagnetic sensor device has a sensing area that excludes the interior volume of the container body, and determining that the non-refuse object is likely inside the container body includes determining that the non-refuse object is no longer detectable by the electromagnetic sensor device.

Particular implementations of the subject matter described in this specification can be implemented so as to realize one or more of the following advantages. The described techniques can be used to implement a packer prevention interlock that prevents operation of a packer to compact refuse inside a compactor when a non-refuse object is inside the compactor.

The described systems and techniques can reduce the risk of damage to the compactor system and prevent injury to people and other living objects. The electromagnetic sensing techniques described herein can improve accuracy of objection detection compared to other sensing techniques. For example, the electromagnetic devices of the present disclosure do not require line-of-sight visibility in order to detect objects proximate the sensor and, therefore, can still accurately perform object detection during vibrations caused by industrial operations and when exposed to dirty environments.

It is appreciated that methods in accordance with the present specification may include any combination of the aspects and features described herein. That is, methods in accordance with the present specification are not limited to the combinations of aspects and features specifically described herein, but also include any combination of the aspects and features provided.

The details of one or more implementations of the subject matter described in this disclosure are set forth in the accompanying drawings and the description below. Other features, objects, and advantages of the subject matter will be apparent from the description and drawings, and from the claims.

### DESCRIPTION OF DRAWINGS

FIG. 1 is a schematic view of an example compactor system according to implementations of the present disclosure.

FIG. 2 shows a block diagram of the example compactor system according to implementations of the present disclosure.

FIGS. 3A to 3H illustrate example operation of a compactor safety system with multiple electromagnetic sensing devices according to implementations of the present disclosure.

FIGS. 4A to 4H illustrate example operation of a compactor safety system with a single electromagnetic sensing device according to implementations of the present disclosure.

FIG. 5 is a flow diagram of an example process for operating a compactor safety system with electromagnetic sensing according to implementations of the present disclosure.

FIG. 6 is a schematic illustration of an example control system or controller for a refuse collection compactor.

### DETAILED DESCRIPTION

Various embodiments of the present disclosure feature a compactor system. The compactor system of the present disclosure includes one or more electromagnetic sensors. The electromagnetic sensor(s) of the compactor system can be used to detect non-refuse objects proximate the compactor. The electromagnetic sensors can include, for example, radar sensors, microwave sensors, infrared sensors, visible light sensors, lidar sensors, ultraviolet sensors, x-ray sensors, gamma ray sensors, or any combination thereof.

A refuse object can be any object or material intended for disposal. Refuse objects can include, for example, trash or recyclable material. Non-refuse objects are any objects or materials that are not intended for disposal. Non-refuse objects can include living objects such as humans and animals, and non-living objects such as autonomous or non-autonomous vehicles.

In general, compactors are used when a customer generates a large volume of compactable material or has limited space for the collection of the material. Compactors can have various shapes and sizes. Example compactor types include vertical compactors, apartment building compactors, and roll-off compactors. Roll-off compactors can be divided into two categories: stationary or breakaway compactors, and self-contained compactors.

Self-contained compactor systems include a container body attached to a compactor in a single, portable structure. A difference between a self-contained compactor and a stationary or breakaway compactor is that a self-contained compactor is not a ground-mounted compactor. When the receiver container is full, the container, with compactor attached, can be picked-up, taken away for disposal, and then returned and reinstalled. Thus, a self-contained compactor can be hauled to a landfill as a single unit to empty the collected refuse. Self-contained compactors are useful when a compactor resides in place for extended periods of time as it collects refuse materials. An application for this type of compactor is for collecting large volumes of compactable wet waste.

Stationary or breakaway compactors include a ground-mounted compactor connected to a removable roll-off receiver container for collecting the waste material. A stationary or breakaway compactor can be used when there are large volumes of dry, compactable materials being generated and there is a large space available. The container is picked-up by a roll-off truck once the container is full. A stationary or breakaway compactor can be used for solid waste and/or recyclable materials.

Vertical Compactors can be used when a customer generates a large volume of waste materials and is limited with space for the collection of the materials. Vertical compactors are serviced by a front load truck. High volume restaurants are a good example of this application.

Apartment compactors can be used in high-rise apartment buildings. These apartment structures can use trash chutes to deliver the waste materials to the collection containers at the lower levels of the building. The waste materials are then compacted into containers which can be picked-up by front load or rear load trucks. Multiple containers can be kept on site and switched out when they are full.

The described techniques are illustrated herein as applied to a self-contained compactor. However, the described techniques can be implemented with any type of compactor.

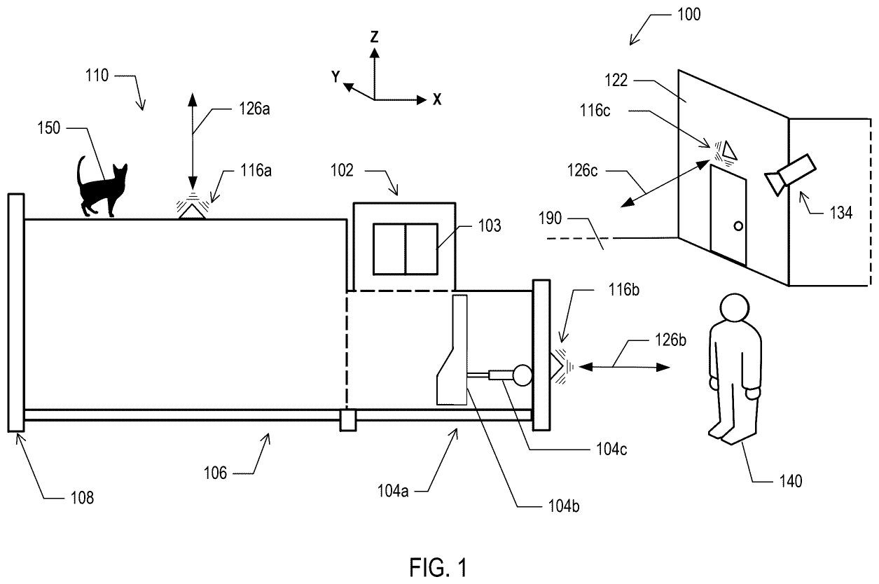

FIG. 1 is a schematic view of an example compactor system 100. The compactor system 100 includes a compactor 110. The compactor 110 is a self-contained compactor. The compactor 110 includes a packer assembly 104a and a container body 106 combined in a single unit.

The compactor 110 collects refuse (e.g., garbage). A hopper 102 is fixedly or removably fastened (e.g., bolted, screwed, riveted, etc.) to the packer assembly 104a, to the container body 106, or both. The container body 106 includes an access 108 that can be opened to empty the contents of the container body 106. The packer assembly 104a includes a packer 104b and an actuator 104c (e.g., an electric or hydraulic actuator) to actuate the packer to compact refuse that is placed in the packer assembly 104a through the hopper 102. The packer 104b compacts the refuse into the container body 106.

The hopper 102 facilitates the input of refuse into the packer assembly 104a. For example, a person can open a door 103 of the hopper 102 and place refuse into the packer assembly 104a through the door 103. Although shown as being on a side of the hopper 102, the door 103 can be located at any part of the hopper 102. For example, the door 103 can be located at a front, back, top or side of the hopper. In some examples, the hopper includes more than one door.

In some examples, the hopper 102 does not include any door. For example, the hopper can include one or more openings that are uncovered. In some examples, a person can place refuse into the packer assembly 104a through an opening in the hopper 102 without opening any door.

The compactor system 100 includes one or more electromagnetic sensor devices. In the example of FIG. 1, the electromagnetic sensor devices include radio detection and ranging (radar) devices 116a, 116b, 116c (“radar devices 116”) that can be used to detect objects proximate the compactor 110. For example, as will be described in further detail herein, the radar device(s) 116 can be used to detect people (e.g., person 140) and animals (e.g., cat 150) near the compactor 110. In some implementations, one or more components 104 of the compactor 110 can be controlled based on the output of the radar devices 116.

The compactor system 100 includes the first radar device 116a mounted to an upper surface of the container body 106 of the compactor 110, a second radar device 116b mounted to a side of the compactor 110, and a third radar device 116c mounted to a nearby structure such as a wall 122. Although shown as including three radar devices 116, the compactor system 100 can include more or fewer radar devices. For example, the compactor system 100 can include one, two, three, four, or more radar devices.

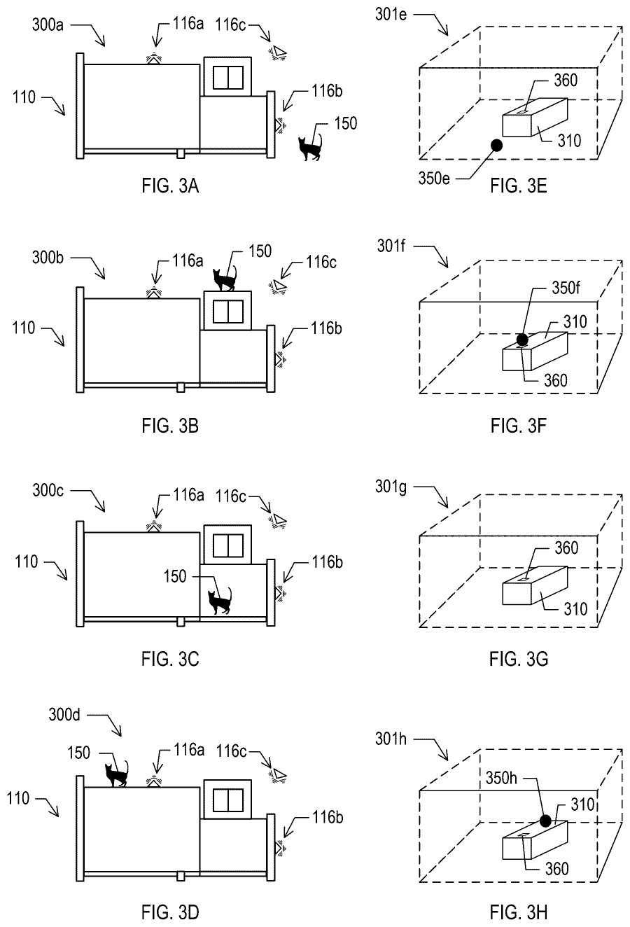

The radar device 116a attached to the upper surface of the container body 106 of the compactor 110 can be used to detect objects positioned above or on top of the compactor 110. The radar device 116b attached to the side of the compactor 110 can be used to detect objects that are proximate to the compactor 110 at or near ground level. The radar device 116c attached to the wall 122 can be used to detect objects approaching and departing from the location of the compactor 110. In some examples, radar data from each of the radar devices 116 is combined to generate a radar plot representing objects near the compactor 110. Example radar plots are described in greater detail with reference to FIGS. 3A to 3H. The radar devices 116 are configured to detect objects proximate the compactor 110 under various conditions, including during various weather and lighting conditions.

The radar device 116a, 116b, 116 can each be a transceiver including an emitter and receiver. To detect objects, an antenna of each of the radar devices 116a, 116b, 116c emits radio waves. Radio waves are waves of electromagnetic radiation having wavelengths corresponding to the radio range of the electromagnetic spectrum (e.g., approximately 0.1 millimeters to 1.0 millimeter wavelength). The radio waves radiate outwards from the respective radar device 116a, 116b, 116c. In some implementations, the radar devices 116a, 116b, 116c are each configured to emit radio waves at a predefined time interval. For example, the radar devices 116a, 116b, 116c can be configured to emit radio waves every thirty milliseconds.

Radio waves emitted by the radar devices 116a, 116b, 116c contact and reflect off of objects that are positioned proximate the respective radar device 116a, 116b, 116c, and the reflected radio waves are detected by a receiver of the respective radar device 116a, 116b, 116c. For example, radio waves reflected off of objects above the upper surface of the container body 106 are detected by a receiver of the radar device 116a and radio waves reflected off of objects on a ground surface near the compactor 110 are detected by a receiver of the radar device 116b.

The radar devices 116a, 116b, 116 can each be a two-dimensional radar device or a three-dimensional radar device. A two dimensional radar device determines a two-dimensional (e.g., <x,y>, <r, 0>) coordinate of a detected object. The two-dimensional coordinate can indicate a lateral position of the detected object relative to the radar device. A three-dimensional radar device determines a three-dimensional (e.g., <x,y,z>, <r, 0, @>) coordinate of the detected object. The three-dimensional coordinate can indicate a lateral position and an elevational position of the detected object relative to the radar device.

The reflected radio waves detected by each of the radar devices 116a, 116b, 116c can be used to form point clouds indicating the presence and position of one or more objects proximate the respective radar devices 116a, 116b, 116c. The point clouds generated by the radar devices 116a, 116b, 116c each include a discrete set of data points in a two-dimensional (2D) or three-dimensional (3D) coordinate system, with each data point corresponding to a point on a surface of an object proximate the compactor 110 within the detection distance 126a, 126b, 126c of the respective radar device 116a, 116b, 116c. Each data point in the point clouds generated by the respective radar device 116 thus has a set of Cartesian or radial coordinates and represents a single point on a surface of an object detected by the respective radar device 116. The coordinates corresponding to each data point in the point cloud generated by the radar device 116a, 116b, 116c can be used to determine the distance and angle of the respective point on the surface of the detected object relative to the radar device 116a, 116b, 116c.

The radar devices 116 are configured to output electromagnetic sensor data, or radar data. In some examples, the electromagnetic sensor data includes the point cloud that indicates the presence and locations of one or more objects proximate the respective radar devices 116.

The coordinates of the data points in the point cloud can be used to determine the angle and distance of the detected object relative to the radar device 116. In particular, as will be described in further detail herein, the point clouds generated by the radar devices 116 can be processed in order to detect, identify, map, and/or track one or more potentially non-refuse objects proximate the compactor 110, such as animals or humans near the compactor 110.

In some implementations, point clouds are generated at a predefined time interval based on updated data received from the radar devices 116 to create a set of point clouds, and the set of point clouds can be processed to detect objects proximate the compactor 110. For example, a new point cloud can be generated every thirty to forty milliseconds based on updated data received from the radar devices 116, and two or more point clouds generated consecutively can be processed in combination to detect and track objects proximate the compactor 110.

In some implementations, the radar devices 116 are configured to output the radar data as analog signals or digital signals indicating the presence of one or more objects proximate the respective radar devices 116. In some implementations, the radar devices 116 are configured to output Controller Area Network (CAN) messages to indicating the presence of one or more objects proximate the respective radar devices 116.

In some implementations, the radar data generated by the radar devices 116a, 116b, 116c is processed by the respective radar device 116a, 116b, 116c in real time to detect objects proximate the compactor 110. For example, the point cloud generated by the radar device 116a can be processed by radar device 116a in real time to detect objects above or on the container body 106 of the compactor 110, and the point cloud generated by the radar device 116b can be processed by radar device 116b in real time to detect objects on the ground surface 190. In some implementations, an object proximate the compactor 110 is detected based on the size of the point cloud and/or the intensity of the points in the point cloud. For example, the radar devices 116a, 116b, 116c can determine that there is an object proximate the respective radar device 116a, 116b, 116c based on detecting that the point cloud generated by the radar device 116a, 116b, 116c is equal to or exceeds a threshold point cloud size and that point cloud includes one of more clusters of points indicating a detected object. In some implementations, clusters indicating the presence of a detected object are portions of the point cloud that have an average intensity of the points within the point cloud equal to or exceeding a threshold intensity.

In some implementations, the radar data generated by the radar devices 116 is processed such that only objects that are positioned within a particular detection distance 126a, 126b, 126c relative to the respective radar device 116a, 116b, 116c are detected. For example, the distance between a particular object and a radar device 116a, 116b, 116c can be determined based on an amount of time that has elapsed between the time that a radio wave was transmitted by the radar device 116a, 116b, 116c and the time that the reflected radio wave was received by the respective radar device 116a, 116b, 116c. Reflected radio waves that are received by the radar device 116a, 116b, 116c after a particular elapsed time that corresponds to distances greater than the respective detection distance 126a, 126b, 126c can be discarded and are not included in the point cloud. As a result, the point cloud only represents objects or other objects that are positioned within the detection distance 126a, 126b, 126c relative to the respective radar device 116a, 116b, 116c. In some implementations, the detection distance 126a relative to the radar device 116a coupled to the container body 106 is in a range of 1 foot to 10 feet. In some implementations, the detection distance 126b relative to the radar device 116b coupled to the front bumper 126 is in a range of five feet to thirty feet. Operations of compactor system 100 and the radar devices 116 are described in greater detail below.

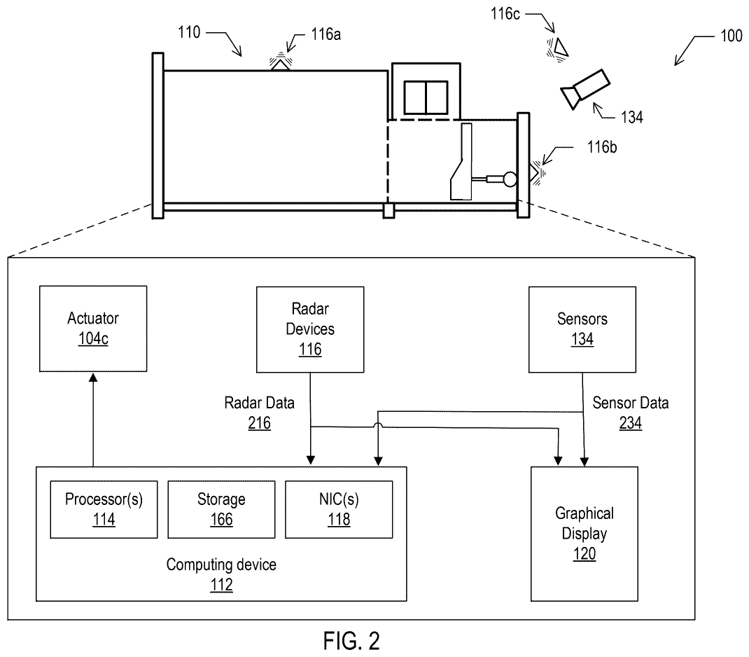

FIG. 2 shows a block diagram of the example compactor system 100. The compactor system 100 includes a computing device 112 and a graphical display 120. The compactor system 100 includes the actuator 104c, the radar devices 116, and one or more sensors 134.

The sensors 134 can include, for example, camera devices, microphones, ultrasonic devices, or any combination of sensors. In some examples, the sensors 134 detect a different type of energy than the electromagnetic sensors (e.g., radar device 116). For example, the radar devices 116 detect electromagnetic energy having wavelengths corresponding to the radio range of the electromagnetic spectrum, and the sensors 134 can detect electromagnetic energy having longer or shorter wavelengths compared to radio wavelengths. In some examples, the radar devices 116 detect electromagnetic energy having wavelengths corresponding to the radio range of the electromagnetic spectrum, and the sensors 134 detect acoustic energy (e.g., audible sound or ultrasonic energy). Sensor data generated by the sensors 134 can be used to supplement the electromagnetic sensor data generated by the radar device 116 in order to detect and/or classify objects proximate the compactor 110.

In some examples, the sensors 134 can sense a position and/or status of one or more components of the compactor 110. For example, the sensors 134 can include a door position sensor that indicates whether the door 103 is open or shut. In some examples, the sensors 134 include a packer position sensor that indicates a position of the packer 104b, such as whether the packer 104b is extended or retracted.

In some implementations, the sensors 134 can be mounted on the compactor 110 or can be present on, in, or near the compactor 110. The sensors 134 each generate sensor data 234. In some examples, the sensor data 234 includes one or more images of a scene external to and in proximity to the compactor 110. In some implementations, one or more sensors 134 are arranged to capture images and/or video of the compactor 110 before, after, and/or during the operations of components 104 to compact refuse in the container body 106. For example, the sensors 134 can be arranged to image objects to the side of, above, and/or behind the compactor 110. In some examples, the sensors 134 can be arranged to image objects to the side of the compactor. In some implementations, the sensors 134 can capture video of a scene external to, internal to, and in proximity to the compactor 110.

In some implementations, the sensors 134 are controlled to capture image data and/or video data of objects detected by the radar devices 116 of the compactor system 100. For example, in response to determining that the radar devices 116 detected a non-refuse object near the compactor 110, the computing device 112 can activate the sensors 134 to cause the sensors 134 to generate sensor data 234, such as images, of the object.

In some implementations, the sensors 134 are communicably coupled to the graphical display 120 to communicate images and/or video captured by the sensors 134 to the graphical display 120. In some implementations, the graphical display 120 is placed at an operating station for the compactor 110 such that the images and/or video can be viewed by an operator of the compactor 110 on a screen of the graphical display 120. The images and/or video captured by the sensors 134 can be communicated to a graphical display 120 of the computing device 112. Images and/or video captured by the sensors 134 can be communicated from the sensors to the computing device 112 over a wired connection (e.g., an internal bus) and/or over a wireless connection. In some implementations, a network bus (e.g., a J1939 network bus, a CAN network bus, etc.) connects the sensors 134 with the computing device 112. In some examples, the sensor data 234 captured by the sensors 134 can be combined with the radar data 216 captured by the radar devices 116 to detect and track objects proximate the compactor 110.

In some implementations, radar data 216 and sensor data 234 can be communicated from the radar devices 116 and the sensors 134, respectively, to the computing device 112. The radar data 216 and the sensor data 234 may be communicated from the radar devices 116 and the sensors 134, respectively, to the computing device 112 over a wired connection (e.g., an internal bus) and/or over a wireless connection. In some implementations, a Society of Automotive Engineers standard J1939 bus in conformance with International Organization of Standardization (ISO) standard 11898 connects the various sensors with the computing device. In some implementations, a Controller Area Network (CAN) bus connects the various the radar devices 116 and the sensors 134 with the computing device 112. For example, a CAN bus in conformance with ISO standard 11898 can connect the various sensors with the computing device.

Analysis of the sensor data 234 and the radar data 216 can be performed at least partly by the computing device 112, e.g., by processes that execute on the processor(s) 114. For example, the computing device 112 can execute processes that perform an analysis of the radar data 216 to detect non-refuse objects proximate the compactor 110, such as animals or humans proximate the compactor 110.

The computing device 112 can include one or more processors 114 that provide computing capacity, data storage 166 of any suitable size and format, and network interface controller(s) 118 that facilitate communication of the computing device 112 with other device(s) over one or more wired or wireless networks.

In some implementations, the compactor 110 includes a body controller that manages and/or monitors various components of the compactor. The body controller of the compactor 110 can be connected to multiple sensors in the body of the compactor. The body controller can transmit one or more signals over the J1939 network, or other wiring on the compactor, when the body controller senses a state change from any of the sensors. These signals from the body controller can be received by the computing device 112 that is monitoring the J1939 network.

In some implementations, the computing device 112 is a multi-purpose hardware platform. The computing device hardware subcomponents can include, but are not limited to, one or more of the following: a CPU, a memory or data storage unit, a CAN interface, a CAN chipset, NIC(s) such as an Ethernet port, USB port, serial port, I2c lines(s), and so forth, I/O ports, a wireless chipset, a global positioning system (GPS) chipset, a real-time clock, a micro SD card, an audio-video encoder and decoder chipset, and/or external wiring for CAN and for I/O. The device can also include temperature sensors, battery and ignition voltage sensors, motion sensors, CAN bus sensors, an accelerometer, a gyroscope, an altimeter, a GPS chipset with or without dead reckoning, and/or a digital can interface (DCI). The DCI cam hardware subcomponent can include the following: CPU, memory, can interface, can chipset, Ethernet port, USB port, serial port, I2c lines, I/O ports, a wireless chipset, a GPS chipset, a real-time clock, and external wiring for CAN and/or for I/O. In some implementations, the computing device 112 is a smartphone, tablet computer, and/or other portable computing device that includes components for recording video and/or audio data, processing capacity, transceiver(s) for network communications, and/or sensors for collecting environmental data, telematics data, and so forth.

In some implementations, based on processing the point cloud generated by the radar devices 116a, 116b, 116c and detecting one or more objects proximate the compactor 110, the radar devices 116a, 116b, 116c can transmit a signal to the computing device 112 of the compactor system 100 indicating the presence of the detected objects. For example, the radar device 116a can transmit a signal to the computing device 112 of the compactor system 100 indicating detected objects above or on top of the compactor system 100 within the detection distance 126a of the radar device 116a. Similarly, the radar device 116b can transmit a signal to the computing device 112 of the compactor system 100 indicating detected objects to the side of the compactor system 100 within the detection distance 126b of the radar device 116b. In some implementations, the radar devices 116a, 116b, 116c transmit a signal to the computing device 112 of the compactor system 100 indicating an angular location relative to the respective radar device 116a, 116b, 116c for each of the detected objects. In some implementations, the angular location of the detected objects relative to the respective radar device 116a, 116b, 116c is provided as (X, Y) Cartesian coordinates. In some implementations, in response to detecting an object proximate the compactor, the radar devices 116a, 116b, 116c can transmit a signal to the computing device 112 as a digital (e.g., discrete) output, for example, a positive indication that an object located is within the respective detection distance 126a, 126b, 126c of the compactor system 100.

In some implementations, in response to receiving a signal from one or more of the radar devices 116a, 116b, 116c indicating that the compactor system 100 is proximate an object, the computing device 112 causes one or more sensors 134 coupled to the compactor system 100 to capture image and/or video data of the object detected by the radar device 116a, 116b, 116c. In some implementations, the sensors 134 are controlled to capture image data and/or video data on a continuous basis or at predetermined intervals, and the image data and/or video data captured by the sensors 134 can be identified as corresponding to a detected object based on a timestamp of the image data and/or video data corresponding a signal received from a radar device 116a, 116b, 116c. The computing device 112 or a remote computing device can process the data captured by the sensors 134 and the signals received from the radar devices 116a, 116b, 116c to determine image and/or video data corresponding to a detected object, and store the corresponding image and/or video data together with other data related to the detected object.

In some implementations, the size of the object and the type of object detected by a radar device 116a, 116b, 116c is determined based on processing the point cloud generated by the radar device 116a, 116b, 116c to detect one or more characteristics of the point cloud corresponding to a particular object type. For example, the point cloud generated by a radar device 116a, 116b, 116c can be processed (e.g., by the radar device 116a, 116b, 116c, by the computing device 112, or by a remote computing device) using machine learning based processing techniques to determine the type of object (e.g., a human, an animal, a vehicle, etc.) corresponding to the respective object detected by the radar device 116a, 116b, 116c. In some implementations, image data and/or video data captured by the sensors 134 of the compactor system 100 can be used to determine the size of the object and the type of object corresponding to the object detected by a radar device 116a, 116b, 116c. For example, image data and/or video data captured by the sensors 134 of the compactor system 100 can be processed (e.g., by the computing device 112 or by a remote computing device) using machine learning based image processing techniques to determine the size of the object and the type of object (e.g., a human, an animal, a vehicle, etc.) corresponding to the respective object detected by a radar device 116a, 116b, 116c.

FIGS. 3A to 3H illustrate example operation of a compactor safety system with multiple electromagnetic sensing devices according to implementations of the present disclosure. FIGS. 3A to 3D show example sequential stages 300a to 300d, respectively, of a scenario in which a cat 150 moves around and inside the compactor 110. As described with reference to FIG. 1, the compactor system 100 includes the compactor 110 and radar devices 116a, 116b, 116c.

FIGS. 3E to 3H show corresponding three-dimensional radar plots 301 for the example stages. Specifically, FIG. 3E shows a three-dimensional radar plot 301e for stage 300a depicted in FIG. 3A, FIG. 3F shows a three-dimensional radar plot 301f for stage 300b depicted in FIG. 3B, FIG. 3G shows a three-dimensional radar plot 301g for stage 300c depicted in FIG. 3C, and FIG. 3H shows a three-dimensional radar plot 301h for stage 300d depicted in FIG. 3D.

The three-dimensional radar plots 301 can be generated by combining radar data 216 from the radar devices 116a, 116b, 116c. For example, radar data 216 from the multiple radar devices 116 can be used to triangulate locations of objects. The triangulated locations of objects are plotted as point clouds in the three-dimensional plots 301.

The three-dimensional radar plots 301 can include mapped locations of fixed objects. For example, the compactor 110 can be a fixed object represented in the radar plots 301 as shape 310. An opening of the compactor 110 (e.g., door 103) can be represented in the radar plots 301 as shape 360. Fixed objects can be classified as background objects in the radar plots 301. Background objects can include, for example, walls (e.g., wall 122), floors (e.g., ground surface 190), ceilings, and other building structures. Background objects can also include foliage and other natural background objects.

The computing device 112 can be configured to detect and track objects that are not classified as background objects. Objects that are not classified as background objects can instead be classified as objects of interest. The computing device 112 can be configured track the location and movement of objects of interest relative to the locations of background objects. For example, the computing device 112 can track objects of interest relative to the location of the shape 310 representing the compactor 110 and the shape 360 representing the door 103.

In some examples, objects can be classified as background objects due to being outside of the field of view of the radar devices 116. For example, a width, height and distance from each radar device can be used to set a field of view for the sensor. The fields of view of the radar devices 116 can form a combined field of view. The computing device 112 can be configured to classify objects in areas outside of the combed field of view as background objects.

In some examples, objects within the combined field of view can be classified as background objects based on one or more characteristics of the objects determined using the radar data 216. For example, the computing device 112 can evaluate a detected object using criteria for objects of interest. The criteria can include a threshold size of the point cloud representing the object (e.g., a minimum size, a maximum size). Detected objects that do not satisfy the criteria for the threshold size for an object of interest can be classified as background objects. In some examples, the computing device evaluates a detected object using movement criteria. The movement criteria can include a threshold speed of movement (e.g., a minimum speed, a maximum speed). Detected objects that do not satisfy the criteria for the threshold speed of movement for an object of interest can be classified as background objects.

Objects detected by the radar devices 116 can be represented in the radar plots 301 as point clouds. The relative sizes of point clouds generally correspond to the relative sizes of the objects represented by the point clouds. For example, point clouds representing dogs are generally larger than point clouds representing cats, point clouds representing birds are generally smaller than point clouds representing cats or dogs, and point clouds representing humans are generally larger than point clouds representing cats, dogs, or birds.

Similarly, shapes of point clouds generally correspond to the shapes of the objects represented by the point clouds. For example, point clouds representing dogs and cats are generally greater in horizontal length than in vertical height, and point clouds representing humans are generally greater in vertical height than in horizontal length.

Referring to FIG. 3A, the cat 150 is near a side of the compactor 110. Referring to FIG. 3E, the cat 150 is represented in the radar plot 301e as point cloud 350e. The point cloud 350e is positioned to the side of shape 310, which represents the compactor 110.

Referring to FIG. 3B, the cat 150 is on top of the compactor 110. Referring to FIG. 3F, the cat 150 is represented in the radar plot 301f as point cloud 350f. The point cloud 350f is positioned above the shape 310 and near the shape 360, which represents the door 103.

Referring to FIG. 3C, the cat 150 is inside the container body of the compactor 110. Referring to FIG. 3G, the radar plot 301g does not include any point cloud representing the cat 150 since the cat 150 inside the compactor is no longer detectable by the radar devices 116.

Referring to FIG. 3D, the cat 150 is on top of the compactor 110. Referring to FIG. 3H, the cat 150 is represented in the radar plot 301h as point cloud 350h. The point cloud 350h is positioned above the shape 310. The point cloud 350h is positioned away from the shape 360.

In some implementations, the positions of objects of interest are tracked over time using signals received from the radar devices 116, and components 104 of the compactor 110 are controlled based on the object tracking. For example, the computing device 112 can receive the radar plots 301e, 301f, 301g, and 301h sequentially in real time or near real-time, and can determine whether to allow packer operation or to prevent packer operation based on analyzing the radar plots 301.

Referring to FIG. 3E, the computing device 112 can analyze the radar plot 301e to determine that an object of interest is detected near the compactor 110. In some examples, the computing device 112 can classify the object as an animal and/or as a cat based on the radar plot 301e.

The computing device 112 can determine, based on the radar plots 301e and 301f, that the cat 150 moved from a position near a side of the compactor 110 to a position that is above or on top of the compactor 110. The computing device 112 can determine that, as represented in the radar plot 301f, the cat 150 is near the door 103 to the compactor 110. The computing device 112 can determine that the cat 150 moved to the position on top of the compactor 110 and near the door 103 based on tracking the point cloud representing the cat 150 over time. In some examples, the computing device 112 determines that the point cloud 350f satisfies criteria for matching a size and/or shape of the point cloud 350e, and therefore that the point cloud 350e and the point cloud 350f likely represent the same object.

The computing device 112 can determine, based on the radar plots 301f and 301g, that the cat 150 likely entered the container body 109 of the compactor 110 through the door 103. The computing device 112 can determine that the cat likely entered the container body 106 of the compactor 110 through the door 103 based on the point cloud 350f being present in the radar plot 301f near the shape 360 representing the door 103, and based on absence of a corresponding point cloud in the radar plot 301g, indicating that the cat 150 likely entered the container body 106 of the compactor 110.

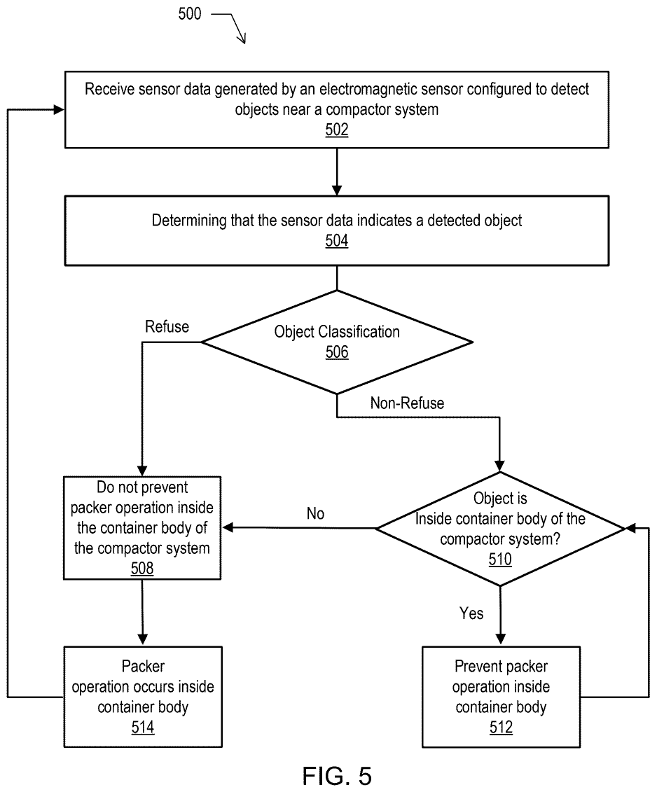

In some examples, in response to determining that the cat 150 likely entered the container body 106 of the compactor 110, the computing device 112 can perform actions such as activating a packer prevention interlock to prevent movement of the packer 104b to compact refuse in the container body 106. Operations that prevent movement of the packer 104b are described in greater detail with reference to FIG. 5. The actions performed by the computing device 112 in response to detecting that a non-refuse object has entered the compactor 110 can additionally or alternatively include activating an alarm, transmitting a notification indicating that the packer prevention interlock is activated, activating additional sensors, or any combination thereof.

After determining that the cat 150 has likely entered the container body 106 of the compactor 110, the computing device 112 can continue to monitor the location of the cat 150 based on additional radar data 216 received from the radar devices 116. For example, the computing device 112 can receive the radar plot 301h that shows a point cloud 350h positioned above the shape 310 and away from the shape 360. The computing device 112 can determine, based on the size and shape of the radar plot 301h, that the cat 150 has likely exited the compactor 110.

In response to determining that the cat has likely exited the container body 106 of the compactor 110, the computing device 112 can perform actions such as deactivating the packer prevention interlock to permit movement of the packer 104b to compact refuse in the container body 106. The actions performed by the computing device 112 in response to detecting that a non-refuse object previously inside the compactor 110 (e.g., cat 150) has exited the compactor 110 can additionally or alternatively include deactivating an alarm, transmitting a notification indicating that the packer prevention interlock is deactivated, deactivating sensors, or any combination thereof.

Although shown as tracking a single point cloud representing a single object (e.g., the cat 150), the described systems can be used to track multiple point clouds representing multiple objects. The computing device 112 can monitor the radar data 216 to determine if any of the multiple objects enter the compactor 110.

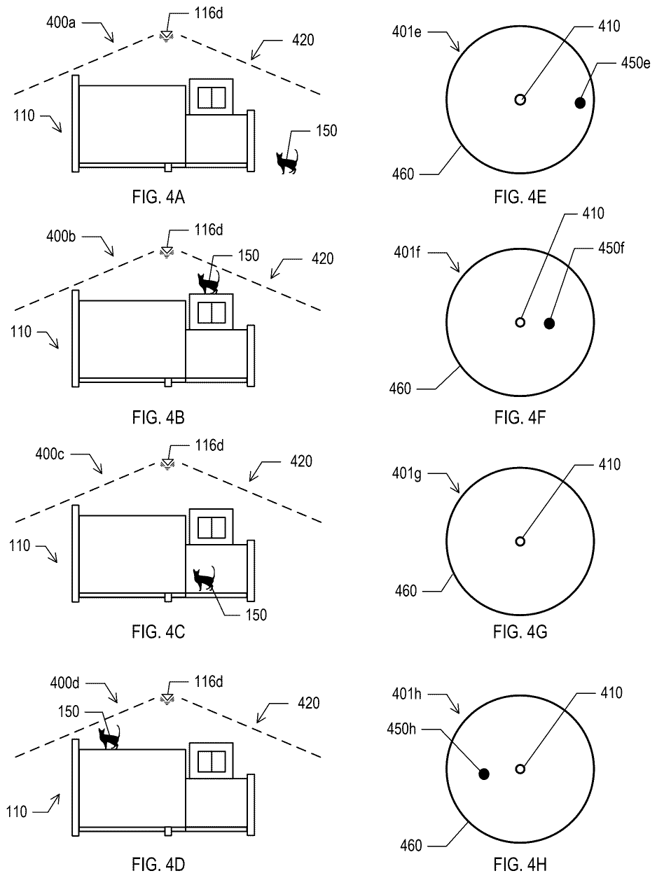

FIGS. 4A to 4H illustrate example operation of a compactor safety system with a single electromagnetic sensing device 116d according to implementations of the present disclosure. FIGS. 4A to 4D show example sequential stages 400a to 400d, respectively, of a scenario in which a cat 150 moves around and inside the compactor 110. The stages 400a to 400d are similar to the stages 300a to 300d that are shown in FIGS. 3A to 3D.

FIGS. 4E to 4H show corresponding three-dimensional radar plots 401 for the example stages 400. Specifically, FIG. 4E shows a two-dimensional radar plot 401e for stage 400a depicted in FIG. 4A, FIG. 4F shows a two-dimensional radar plot 401f for stage 400b depicted in FIG. 4B, FIG. 4G shows a two-dimensional radar plot 401g for stage 400c depicted in FIG. 4C, and FIG. 4H shows a two-dimensional radar plot 401h for stage 400d depicted in FIG. 4D.

The radar plots 401 are generated by the radar device 116d. In the example of FIGS. 4A to 4H, the radar device 116d is positioned above the compactor 110 and near a center of the compactor 110. The radar device 116d has a field of view having borders represented by dashed lines 420. In some examples, the field of view 420 of the radar device 116d has a conical shape or a half-sphere shape. In general, the field of view 420 of the radar device 116d includes areas around the outside of the compactor 110, and excludes the interior volume of the compactor 110. The field of view likely excludes the interior volume of the compactor 110 because the electromagnetic radiation does not penetrate the walls of the compactor 110.

In some examples, the radar device 116d is positioned to detect objects inside the interior volume of the compactor 110. For example, the compactor 110 can include one or more openings that face in the direction of the radar device 116d. In these examples, the sensing area, or field of view, of the radar device 116d can include at least part of the interior volume of the compactor. For example, the field of view of the radar device 116d may be able to detect objects inside the hopper of the compactor.

The radar device 116d can generate two-dimensional or three-dimensional radar data. The radar plots 401 are shown in two-dimensions for simplicity of illustration, with each point cloud having a two-dimensional position (e.g., in x-y coordinates, in r-θ coordinates) relative to the radar device 116. However, in some examples, each point cloud depicted in the radar plots 401 has a three-dimensional position (e.g., in x-y-z coordinates, in r-θ-φ coordinates) relative to the radar device 116.

The radar plots 401e to 401 h each have a center point 410 corresponding to the location of the radar device 116d, and an outer boundary 460 corresponding to a maximum sensing range of the radar device 116d. Thus, objects nearer to the center of the compactor 110 are represented by point clouds that are nearer to the center point 410 of the radar plots 401 generated by the radar device 116d. Objects farther from the center of the compactor 110 are represented by point clouds that are farther away from the center point 410 of the radar plots 401 generated by the radar device 116d.

Referring to FIG. 4A, the cat 150 is near a side of the compactor 110. Referring to FIG. 4E, the cat 150 is represented in the radar plot 401e as point cloud 450e. The point cloud 450e is positioned near the outer boundary 460.

Referring to FIG. 4B, the cat 150 is on top of the compactor 110. Referring to FIG. 4F, the cat 150 is represented in the radar plot 401f as point cloud 450f. The point cloud 450f is nearer to the center point 410 than the point cloud 450e.

Referring to FIG. 4C, the cat 150 is inside the compactor 110. Referring to FIG. 4G, the radar plot 401g does not include any point cloud representing the cat 150.

Referring to FIG. 4D, the cat 150 is on top of the compactor 110. Referring to FIG. 4H, the cat 150 is represented in the radar plot 401h as point cloud 450h. The point cloud 450h is positioned farther from the center point 410 than the point cloud 450f, on an opposite side of the center point 410.

The computing device 112 can receive the radar plots 401e, 401f, 401g, and 401 h sequentially in real time or near real-time, and can determine to allow packer operation or to prevent packer operation based on analyzing the radar plots 401.

Referring to FIG. 4E, the computing device 112 can analyze the radar plot 401e to determine that an object of interest is detected near the compactor 110. In some examples, the computing device 112 can classify the object as an animal and/or as a cat based on the radar plot 401e.

The computing device 112 can determine, based on the radar plots 401e and 401f, that the cat 150 moved from a position farther from the compactor 110 to a position that is nearer to the compactor 110.

The computing device 112 can determine, based on the radar plots 401f and 401g, that the cat 150 likely entered the container body 106 of the compactor 110. The computing device 112 can determine that the cat 150 likely entered the container body 106 of the compactor 110 based on the point cloud 450f being present in the radar plot 401f, and based on absence of a corresponding point cloud in the radar plot 401g. In some examples, the computing device 112 determines that the cat 150 likely entered the container body 106 of the compactor 110 based on determining that (1) the cat 150 is no longer detectable by the radar sensor 116d and (2) the cat 150 did not depart the field of view of the radar device 116d by passing through the maximum sensing range of the radar device 116 represented by the outer boundary 460.

In some examples, one or more radar sensors can be positioned to detect objects inside the compactor and the radar can be used to detect objects that are present inside the compactor. For example, the radar sensor can have a sensing area that includes at least part of an interior volume of the container body. Determining that the non-refuse object is likely inside the container body can include determining that the sensor data generated by the radar sensor includes a detection of the non-refuse object at the sensing area that includes the at least part of the interior volume of the container body. In this way, radar data generated by a radar sensor positioned in the compactor or at or near an opening of the compactor can be used to determine that the cat is present inside the compactor.

In some examples, in response to determining that the cat 150 likely entered the container body 106 of the compactor 110, the computing device 112 can perform actions such as activating a packer prevention interlock to prevent movement of the packer 104b to compact refuse in the container body 106. Operations that prevent movement of the packer 104b are described in greater detail with reference to FIG. 5. The actions performed by the computing device 112 in response to detecting that a non-refuse object has entered the container body 106 of the compactor 110 can additionally or alternatively include activating an alarm, transmitting a notification indicating that the packer prevention interlock is activated, activating additional sensors, or any combination thereof.

After determining that the cat 150 has likely entered the container body 106 of the compactor 110, the computing device 112 can continue to monitor the location of the cat 150 based on additional radar data 216 received from the radar device 116d. For example, the computing device 112 can receive the radar plot 401h that shows the point cloud 450h positioned away from the center point 410. The computing device 112 can determine, based on the radar plot 401h, that the cat 150 has likely exited the compactor 110.

In some examples, one or more radar sensors can be positioned to detect objects inside the compactor and the radar can be used to detect departure of objects from the compactor. For example, radar data generated by a radar sensor positioned in the compactor or at or near an opening of the compactor can be used to determine that the cat has exited the compactor and/or is no longer inside the compactor. In some cases, the computing device 112 can determine that the cat has departed form the compactor 110 based on the radar sensor no longer detecting the cat.

In response to determining that the cat has likely exited the compactor 110, the computing device 112 can perform actions such as deactivating the packer prevention interlock to permit movement of the packer 104b to compact refuse in the container body 106. The actions performed by the computing device 112 in response to detecting that a non-refuse object previously inside the compactor 110 (e.g., cat 159) has exited the compactor 110 can additionally or alternatively include deactivating an alarm, transmitting a notification indicating that the packer prevention interlock is deactivated, deactivating sensors, or any combination thereof.

The computing device 112 can continue to track movement of the cat 150 until the cat 150 departs the field of view of the radar device 116d by passing through the maximum sensing range of the radar device 116d represented by the outer boundary 460. As the cat 150 gradually moves away from the radar device 116d, the radar detection signal resulting from the presence of the cat 150 decreases until the radar device 116d can no longer detect the cat 150. When the cat 150 passes beyond the maximum detection range of the radar device 116d, the radar plot generated based on the radar data 216 generated by the radar device 166d will no longer show a point cloud corresponding to the cat 150, and the computing device 112 can determine that the cat has departed from the field of view of the radar device 116d by passing through the maximum sensing range.

Although shown as tracking a single point cloud representing a single object (e.g., the cat 150), the described systems can be used to track multiple point clouds representing multiple objects. The computing device 112 can monitor the radar data 216 to determine if any of the multiple objects enter the compactor 110.

FIG. 5 is a flow diagram of an example process 500 for operating a compactor safety system with electromagnetic sensing. The process 500 can be implemented by, for example, a controller or control system (e.g., computing device 112 of the compactor safety system 100). Steps of the process 500 may occur in the illustrated sequence, or in a sequence that is different from the illustrated sequence. For example, some of the steps may occur concurrently.

The control system receives sensor data generated by an electromagnetic sensor configured to detect objects near a compactor system (502). The electromagnetic sensor device generates sensor data indicating the detected objects near the compactor system. The electromagnetic sensor can be, for example, a radar sensor. In some examples, the control system provides a visual representation of the electromagnetic sensor data for presentation on a display.

The control system determines that the sensor data indicates a detected object (504). For example, the control system can determine that the radar data 216 includes a point cloud that represents an object. In some examples, the control system classifies each object as an object of interest or as a background object. Objects of interest can include, for example, humans, animals, vehicles, and refuse. Background objects can include, for example, walls, doors, floors, compactor components, ceilings, foliage, signposts, and flagpoles.

The control system classifies the detected object (506). The control system can classify the object as refuse or as non-refuse. In some examples, the control system classifies the detected object as a living object. In some examples, the control system classifies the detected object as a human or animal.

In some examples, the control system classifies the detected object as a refuse or non-refuse object by generating a point cloud from the electromagnetic sensor data and preforming object classification using the point cloud. For example, the point cloud generated by can be processed using one or more machine learning models to determine the type of object (e.g., a human, an animal, a vehicle, etc.) corresponding to the respective detected object.

The machine learning models can be trained to classify objects based on the radar data 216, the sensor data 234, or a combination of both. For example, the machine learning models can be trained using training samples of radar data generated by detecting various objects with radar devices. The training samples can be labeled according to the type of object detected. In some examples, the training samples can be labeled with categories of “refuse” or “non-refuse.” In some examples, the training samples can be labeled with subcategories. For example, training samples representing refuse objects can be labeled with subcategories of “trash bag,” “box,” “furniture,” and “paper” corresponding to the types of detected objects. Training samples representing non-refuse objects can be labeled with subcategories of “human,” “dog,” “cat,” “squirrel,” and “bird,” corresponding to the types of detected objects.

The training samples can include radar data from one radar device or multiple radar devices. In some examples, the training samples include radar data captured over a period of time. For example, a first training sample can include radar data captured over a period of time during which a human approaches a compactor system and then moves away from the compactor system. The first training sample can be labeled “human,” “non-refuse,” or both. A second training sample can include radar data captured over a period of time during which a piece of paper floats in the wind around a compactor system. The second training sample can be labeled “paper,” “refuse,” or both. The machine learning models can be trained using the first training sample and the second training sample, along with many (e.g., thousands, hundreds of thousands) of additional samples. The machine learning models can be trained to recognize shapes, sizes, and movement patterns of refuse and non-refuse objects.

In some examples, in addition to or instead of classifying the object using machine learning techniques, the control system classifies the detected object as a refuse or non-refuse object based on one or more rules. For example, the control system can determine an approximate size of a detected object based on the sensor data and can apply one or more rules specifying likely sizes of refuse objects and non-refuse objects. An example rule can specify a minimum threshold size of a non-refuse object (e.g., thirty centimeters long, forty centimeters long). Another example rules can specify a maximum threshold size of a non-refuse object (e.g., two meters tall).

In some examples, the control system classifies the detected object as a refuse or non-refuse object based on a shape of the object. For example, the control system can determine an approximate shape of a detected object based on the sensor data and can apply one or more rules specifying likely shapes of refuse objects and non-refuse objects. An example rule can specify shape characteristics of likely refuse objects (e.g., prismic, cubic, flat).

In some examples, the control system classifies the detected object as a refuse or non-refuse object based on direction and/or speed of movement of the object. For example, the control system can determine an approximate direction and/or speed of movement of a detected object based on the sensor data and can apply one or more rules specifying likely movement patterns of refuse objects and non-refuse objects. An example rule can specify a maximum threshold speed for a refuse object (e.g., one meter per second).

In response to classifying the detected object as refuse, the control system does not prevent packer operation inside the container body of the compactor system (508). For example, the control system can determine not to send a signal to the actuator 104c to prevent movement of the packer 104b within the container body 106.

In response to classifying the detected object as non-refuse, the control system determines whether the detected object is inside the container body of the compactor system (510). In some examples, the control system determines that the object is likely inside the compactor system by determining that the detected object departed the sensing area of the electromagnetic sensor device, and that the detected object did not pass through the maximum sensing range of the electromagnetic sensor device. For example, the object can depart the sensing area of the electromagnetic sensor device by entering the compactor 110.

In some examples, the control system determines that the object is likely inside the compactor system by determining, based on the sensor data, that the detected object entered the container body 106 of the compactor system through an opening. In some examples, the control system can determine, based on the electromagnetic sensor data, that the object did not depart from the container body 106 of the compactor system after the object entered the compactor system. In some examples, the radar sensor is positioned to detect objects inside the compactor based on detecting the presence of the object inside the compactor.

In some examples, the control system determines that the object is likely inside the compactor system by determining that a human approached the compactor system and determining that a door of the compactor system opened after the human approached the compactor system or was open when the human approached the compactor system. In some examples, the control system can receive door sensor data from a door sensor configured to detect a position of a door to the compactor system. The control system can determine the position of the door when the human approached the compactor system based on the door sensor data.

In response to determining that the detected object is not inside the compactor system, the control system does not prevent packer operation inside the container body of the compactor system (508). For example, the control system can determine not to send a signal to the actuator 104c to prevent movement of the packer 104b.

As a result of the control system not preventing packer operation, packer operation occurs inside the container body of the compactor system (514). For example, the actuator 140c operates to move the packer 104b to compact refuse inside the container body 106. In some examples, the control system resets after the packer operation occurs 514, and begins monitoring radar data 216 for any non-refuse objects that may approach the compactor system 100 prior to the next compaction cycle.

In response to determining that the non-refuse object is inside the compactor system, the control system prevents packer operation inside the container body of the compactor system (512). For example, the control system can prevent the actuator 104c from operating to move the packer 104b. In some examples, the actuator 104c is a hydraulic actuator and the control system sends an electrical signal to one or more electrically-operated hydraulic valves that causes the valves to remain in a current position, preventing hydraulic movement of the actuator 104c. In some examples, the actuator 104c is an electronic actuator and the control system sends an electrical signal to the actuator 104c that causes the actuator 104c to remain in a current position.

In some examples, the control system prevents operation of the packer by removing power to the actuator 104c and/or to one or more valves that control movement of the actuator 104c. For example, the control system can send an electrical signal that causes an electrical switch to open, disabling the actuator 104c.

In some examples, the control system prevents operation of the packer 104b by disabling a manual control of the actuator 104c. For example, the compactor system 100 can include a button or switch that enables an operator to activate the actuator 104c. The control system can remove power to the button or switch, disabling the manual control of the actuator 104c and preventing packer operation.

In some examples, in response to determining that the non-refuse object is inside the compactor system, the control system activates an alarm or alert. For example, the control system can cause a visual alert and/or an audible alert to be generated that alerts an operator of the compactor system 100 to the presence of the detected object. In some examples, the visual or audible alert is activated near and/or in the compactor system 100, such that a person near and/or in the compactor 110 would likely hear and/or see the alert. In some examples, the visual or audible alert is presented through a computer system, such as by a notification presented on a computing device with a display.

In some examples, after determining that a non-refuse object is likely inside the compactor system, the control system continues to monitor the presence and location of the object until the control system determines, based on additional radar data, that the non-refuse object has departed from the compactor system 100. For example, the control system can track movement of the non-refuse object using additional radar data 216 generated by the radar device 116, additional sensor data 234 generated by the sensors 134, or both. The control system can determine that the non-refuse object has departed from the compactor system 100 based on detecting the non-refuse object moving away from the compactor system 100 until the non-refuse object is no longer detectable by the radar devices 116 and/or the sensors 134. In some examples, the radar sensor is positioned to detect objects inside the compactor and the object can be determined to have exited to compactor by the radar sensor no longer detecting the presence of the object inside the compactor.

In some examples, the compactor system 100 includes a control element that enables an operator to reset the packer prevention interlock in order to permit packer operation. For example, after packer operation is prevented and an alert is activated, an operator can investigate the compactor system 100. The operator may remove the non-refuse object from the compactor system 100 or may determine that there is no non-refuse object in the compactor system 100. The operator can activate the control element in order to reset the packer prevention interlock, enabling packer operation once again. The control element can be, for example, a switch, a button, a graphical user interface element, or any combination of these. In some examples, additional safeguards are provided to prevent accidental resetting of the packer prevention interlock. For example, a key or a password may be required in order to activate the reset control element.

Although the preceding detailed description contains many specific details for purposes of illustration, it is understood that one of ordinary skill in the art will appreciate that many examples, variations and alterations to the details are within the scope and spirit of the disclosure. Accordingly, the exemplary implementations described in the present disclosure and provided in the appended figures are set forth without any loss of generality, and without imposing limitations on the claimed implementations.

Although the present implementations have been described in detail, it should be understood that various changes, substitutions, and alterations can be made hereupon without departing from the principle and scope of the disclosure. Accordingly, the scope of the present disclosure should be determined by the following claims and their appropriate legal equivalents.

The singular forms “a”, “an” and “the” include plural referents, unless the context clearly dictates otherwise.

As used in the present disclosure and in the appended claims, the words “include,” “has,” and “include” and all grammatical variations thereof are each intended to have an open, non-limiting meaning that does not exclude additional elements or steps.

As used in the present disclosure, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is contemplated under the scope of the present disclosure.

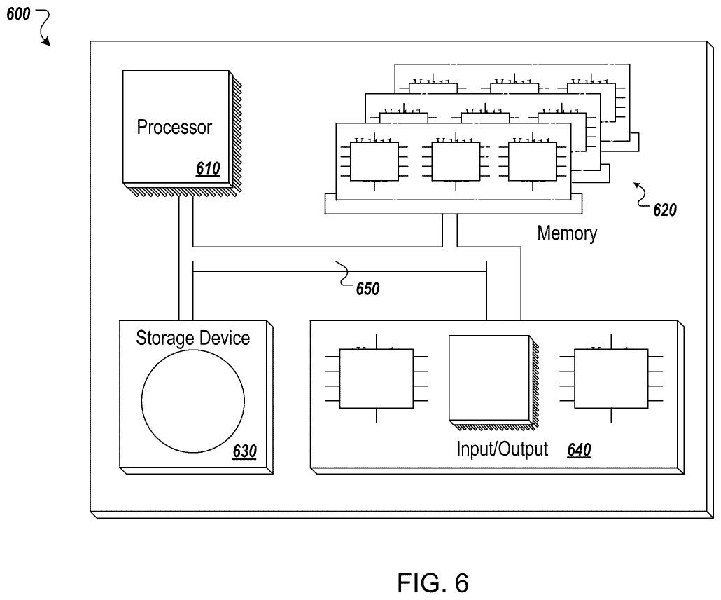

FIG. 6 is a schematic illustration of an example control system or controller for a waste collection compactor according to the present disclosure. For example, the controller 600 may include or be part of the onboard computer system. The controller 600 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 600 includes a processor 610, a memory 620, a storage device 630, and an input/output device 640. Each of the components 610, 620, 630, and 640 are interconnected using a system bus 650. The processor 610 is capable of processing instructions for execution within the controller 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the controller 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the controller 600. In one implementation, the storage device 630 is a computer-readable medium. In various different implementations, the storage device 630 may be a floppy disk device, a hard disk device, an optical disk device, or a tape device.

The input/output device 640 provides input/output operations for the controller 600. In one implementation, the input/output device 640 includes a joystick. In some implementations, the input/output device 640 includes a display unit for displaying graphical user interfaces. For example, in some implementations, the input/output device 640 is a display device that includes one or more buttons and/or a touchscreen for receiving input from a user. In some implementations, the input/output device 640 includes a keyboard and/or a pointing device.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device.

Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

By real time it is meant that energy data collected during a collection operation (e.g., the compactor's performance of a refuse collection route) is processed to provide automatic control or to adjust operating parameters during the same operation (e.g., during the same refuse collection route). The timeliness may depend, for example, on the quantity of data collected, the complexity of the processing, and whether or not cloud processing is implemented. In some implementations, real time can mean within one second, one minute, five minutes, ten minutes, thirty minutes, one hour, or two hours.

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

What is claimed is:

1. A compactor system comprising:
a container body;
a packer; and
an actuator configured to operate the packer to compact refuse within the container body;
an electromagnetic sensor device configured to detect objects near the compactor system and to generate sensor data indicating the detected objects near the compactor system;
a control system configured to perform operations comprising:
receiving the sensor data generated by the electromagnetic sensor device, wherein the sensor data indicates a detected object;
classifying the detected object as a non-refuse object based on the sensor data;
determining that the non-refuse object is likely inside the container body; and
in response to determining that the non-refuse object is likely inside the container body, controlling the actuator to prevent compaction of the refuse by the packer.

2. The compactor system of claim 1, wherein classifying the detected object as a non-refuse object comprises classifying the detected object as a living object.

3. The compactor system of claim 2, wherein classifying the detected object as a living object comprises classifying the detected object as a human or animal.

4. The compactor system of claim 1, wherein:
the electromagnetic sensor device has a sensing area defined at least in part by a maximum sensing range, and
determining that the non-refuse object is likely inside the container body comprises:
determining that the detected object departed the sensing area of the electromagnetic sensor device; and
determining that the detected object did not pass through the maximum sensing range of the electromagnetic sensor device.

5. The compactor system of claim 1, wherein determining that the non-refuse object is likely inside the container body comprises:
determining, based on the sensor data, that the non-refuse object entered the container body through an opening.

6. The compactor system of claim 5, wherein determining that the non-refuse object is likely inside the container body comprises:
determining, based on the sensor data, that the non-refuse object did not depart from the container body after the object entered the container body.

7. The compactor system of claim 1, wherein classifying the detected object as a non-refuse object comprises:
generating a point cloud from the sensor data; and
performing object classification using the point cloud.

8. The compactor system of claim 1, wherein:
classifying the detected object as a non-refuse object comprises classifying the detected object as a human; and
determining that the non-refuse object is likely inside the container body comprises:
determining, based on the sensor data, that the human approached the compactor system;
receiving door sensor data from a door sensor configured to detect a position of a door to the compactor system; and
determining that the human is likely inside the container body in response to determining, based on the door sensor data, that that the door opened after the human approached the compactor system.

9. The compactor system of claim 1, wherein:
classifying the detected object as a non-refuse object comprises classifying the detected object as a living object; and
determining that the non-refuse object is likely inside the container body comprises:
determining, based on the sensor data, that the living object approached the compactor system;
receiving door sensor data from a door sensor configured to detect a position of a door to the compactor system; and
determining that the living object is likely inside the container body in response to determining, based on the door sensor data, that the door was open when the living object approached the compactor system.

10. The compactor system of claim 1, wherein a refuse object comprises an object to be disposed.

11. The compactor system of claim 1, the operations comprising:
determining that the non-refuse object has exited the container body;
receiving second sensor data generated by the electromagnetic sensor device, wherein the sensor data indicates a second object;
classifying the second object as a refuse object based on the sensor data; and
in response to (i) determining that the non-refuse object has exited the container body and (ii) classifying the second object as a refuse object, determining not to control the actuator to prevent compaction of the refuse by the packer.

12. The compactor system of claim 1, the operations comprising:
providing, for presentation on a display, a visual representation of the sensor data.

13. The compactor system of claim 1, the operations comprising:
in response to determining that the non-refuse object is likely inside the container body, activating an alarm.

14. The compactor system of claim 1, wherein the electromagnetic sensor device comprises an electromagnetic transceiver.

15. The compactor system of claim 1, wherein the electromagnetic sensor device comprises a radar sensor or a lidar sensor.

16. The compactor system of claim 1, wherein the electromagnetic sensor device is mounted to the compactor system or to a structure near the compactor system.

17. The compactor system of claim 1, comprising a stationary compactor.

18. The compactor system of claim 1, wherein the electromagnetic sensor device has a sensing area that includes at least part of an interior volume of the container body, and determining that the non-refuse object is likely inside the container body comprises determining that the sensor data generated by the electromagnetic sensor device indicates a detection of the non-refuse object in the interior volume of the container body.

19. The compactor system of claim 1, wherein the electromagnetic sensor device has a sensing area that excludes an interior volume of the container body, and determining that the non-refuse object is likely inside the container body comprises determining that the non-refuse object is no longer detectable by the electromagnetic sensor device.

20. A method of operating a compactor system comprising a container body, a packer, and an actuator configured to operate the packer to compact refuse within the container body, the method comprising:
receiving sensor data generated by an electromagnetic sensor device that is configured to detect objects near the compactor system,
determining that the sensor data indicates a detected object;
classifying the detected object as a non-refuse object based on the sensor data;
determining that the non-refuse object is likely inside the container body; and
in response to determining that the non-refuse object is likely inside the container body, controlling the actuator to prevent compaction of the refuse by the packer.

21. A non-transitory computer storage medium encoded with instructions that, when executed by one or more computers, cause the one or more computers to perform operations for operating a compactor system comprising a container body, a packer, and an actuator configured to operate the packer to compact refuse within the container body, the operations comprising:
receiving sensor data generated by an electromagnetic sensor device that is configured to detect objects near the container body,
determining that the sensor data indicates a detected object;
classifying the detected object as a non-refuse object based on the sensor data;
determining that the non-refuse object is likely inside the container body; and
in response to determining that the non-refuse object is likely inside the container body, controlling the actuator to prevent compaction of the refuse by the packer.
